(19) United States
(12) Patent Application Publication
(10) Pub. No.: US 2017/0270839 A1
(43) Pub. Date: Sep. 21, 2017

(54) Apparatus For Securing A Vehicle Flag Device

(71) Applicant: PT FLAGS PTY LTD, South Wales (AU)

(72) Inventor: Patrick Buckley, Perth (AU)

(21) Appl. No.: 15/528,517

(22) PCT Filed: Oct. 29, 2015
(86) PCT No.: PCT/AU2015/050675

§ 371 Date: Jun. 5, 2017

(30) Foreign Application Priority Data
Nov. 21, 2014 (AU) 2014904718

(51) Int. Cl. G09F 17/00; F16M 13/02; F16M 11/04; G09F 7/10

(52) U.S. Cl. CPC G09F 17/00; G09F 7/10; F16M 13/022; F16M 11/041; G09F 2017/0075; G09F 2017/0066; G09F 2017/005; G09F 21/04

(57) ABSTRACT

There is provided apparatus for securing a vehicle flag device. The apparatus comprises a base comprising a door entrapment protrusion configured for protruding between closing surfaces of a door of a vehicle body in use so as to entrap the protrusion; a surface fastener configured for fastening an underside of the base to the roof of the vehicle body substantially adjacent the door in use; and a flag device secured by the base. In use the door entrapment protrusion is configured so as to substantially prevent the removal of the base from the vehicle while the door is closed; and the surface fastener is configured to secure the base to the vehicle body so as to adequately support the flag device and secure the base to the roof while the vehicle is moving.

### CROSS-REFERENCE TO RELATED APPLICATIONS

This application is a national stage application of the PCT international application titled “Apparatus For Securing A Vehicle Flag Device”, international application number PCT/AU2015/050675, filed in the Australian Patent Office on Oct. 29, 2015, which claims priority to and the benefit of the provisional patent application titled “Vehicle Flag System”, provisional patent application number 2014904718, filed in the Australian Patent Office on Nov. 21, 2014, and the national phase application titled “Apparatus for securing a vehicle flag device”, national phase application number 2015349606, filed in the Australian Patent Office on Sep. 27, 2016. The specifications of the above referenced patent applications are incorporated herein by reference in their entirety.

### FIELD OF THE INVENTION

The present invention relates to apparatus for securing a vehicle flag device.

### SUMMARY OF THE DISCLOSURE

According to one aspect, there is provided apparatus for securing a vehicle flag device, the apparatus comprising a base comprising a door entrapment protrusion configured for protruding between closing surfaces of a door of a vehicle body in use so as to entrap the protrusion; a surface fastener configured for fastening an underside of the base to the roof of the vehicle body substantially adjacent the door in use; and a flag device secured by the base, wherein, in use the door entrapment protrusion may be configured so as to substantially prevent the removal of the base from the vehicle while the door may be closed; and the surface fastener may be configured to secure the base to the vehicle body so as to adequately support the flag device while the vehicle may be moving.

The base may be substantially low profile.

The base may be substantially elongate along the intended direction of travel so as to provide resilience to wind force.

The base may be configured to conform to a contour of the vehicle body in use.

The base may comprise a curved undersurface configured to conform to the contour.

The base may be substantially flexible so as to adapt to the contour.

The door entrapment protrusion may comprise a widened distal end stop configured to hinder the pulling of the protrusion from between the closing surfaces.

The door entrapment protrusion may be substantially S-shaped.

The door entrapment protrusion may be flexible.

The surface fastener may be magnetic.

The base defines an upper recess for receiving a magnet therein.

The base may further comprise an engagement means configured for releasably engaging the flag device in use.

The flag device may comprise a foot and wherein the engagement means may be substantially elongate, open at at least one end and configured for slidable receipt of the foot therein use.

The engagement means may comprise an upper slit to allow the flag device to protrude therefrom.

The foot may be substantially elongate.

The foot may be tapered at an insertion end.

The foot may comprise a stop opposite an insertion end.

The flag device may comprise an upright stem configured for supporting flag material.

The upright stem may be configured of the non-releasable engagement of the flag material.

The upright stem may comprise one-way arrowheads.

Other aspects of the invention are also disclosed.

### BRIEF DESCRIPTION OF THE DRAWINGS

Notwithstanding any other forms which may fall within the scope of the present invention, a preferred embodiments of the disclosure will now be described, by way of example only, with reference to the accompanying drawings in which:

FIG. 1 shows an exploded view of apparatus for securing a vehicle flag device in accordance with an embodiment of the present disclosure;

FIG. 2 shows the assembled apparatus of FIG. 1 in accordance with an embodiment of the present disclosure;

FIG. 3 shows a side view of the base of the apparatus of FIG. 1, especially showing the door entrapment protrusion in further detail in accordance with an embodiment of the present disclosure;

FIGS. 4 and 5 show flag device variants in accordance with further embodiments of the present disclosure; and

FIG. 6 shows a top view of the base of the apparatus of FIG. 1 in accordance with an embodiment of the present disclosure.

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to the apparatus for securing a vehicle flag device are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

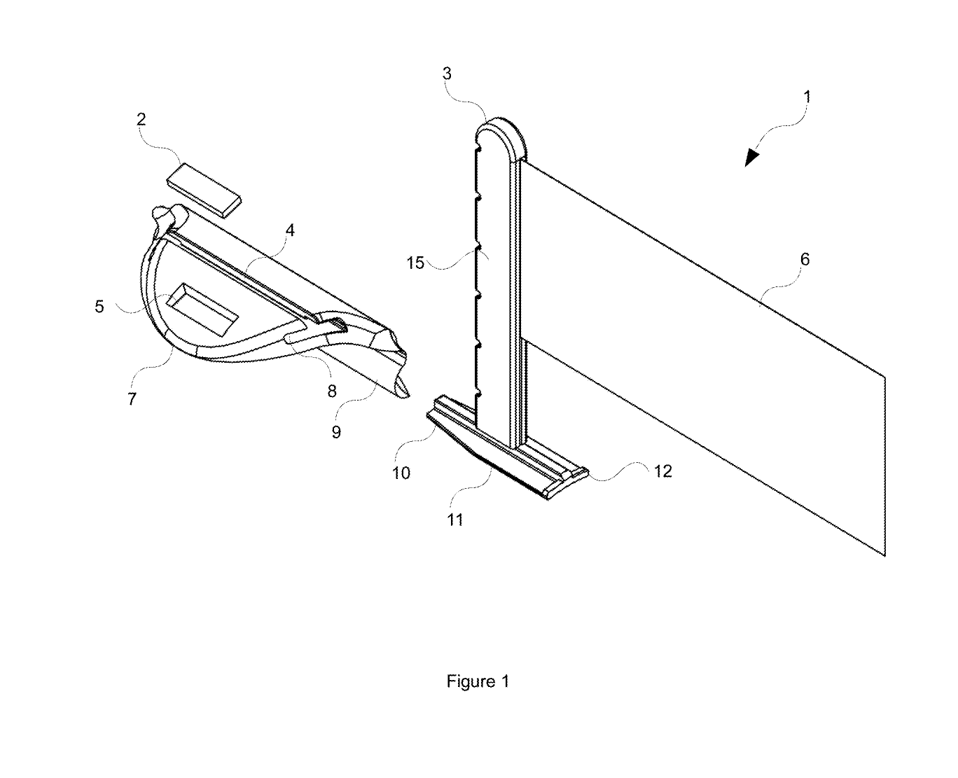

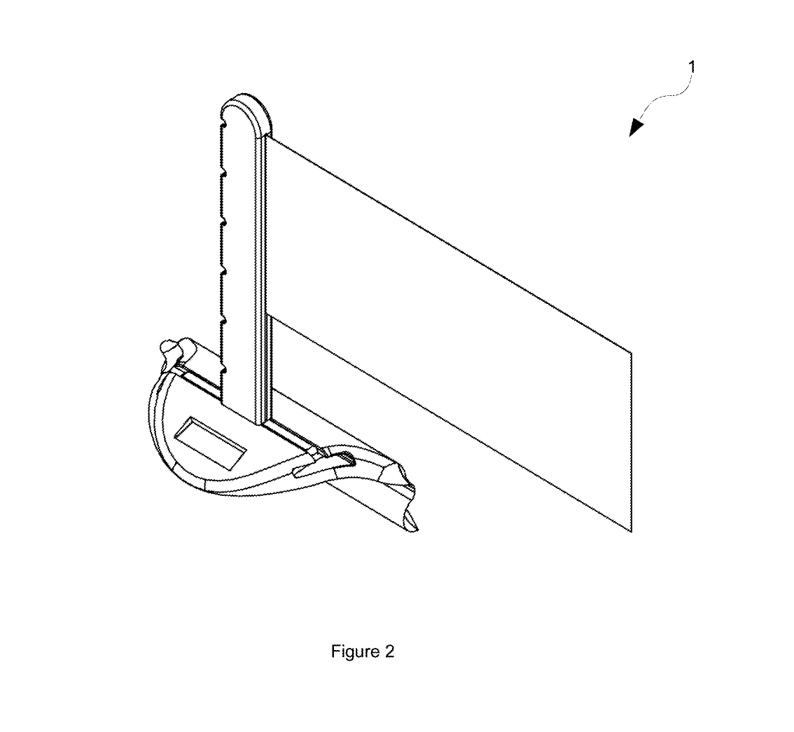

Turning now to FIG. 1, there is shown apparatus 1 for securing a vehicle flag device. As will become apparent from the ensuing description, the apparatus 1 is configured for securement to a roof of a vehicle (or other locations of the vehicle, such as the boot, bonnet or the like) so as to present a flag (or other indicia such as pom-poms, mascots and the like) for novelty or visual indication requirement purposes.

As will further become apparent from the ensuing description, the apparatus 1, in a preferred embodiment, is configured to reduce theft of the apparatus 1 wherein, in use, the apparatus 1 resists removal from the vehicle while the doors (or boot or bonnet) of the vehicle remain closed. Furthermore, in embodiments, the flag device is removable from the base of the apparatus, so as to allow for simple replacement while the base of the apparatus is in place or for safekeeping.

Now, as can be seen from FIG. 1, the apparatus 1 comprises a base 7. The base 7 comprises a door entrapment protrusion 9 configured for protruding between closing services of a door (or boot or bonnet) of a vehicle body in use so as to entrap the protrusion. As alluded to above, the door entrapment protrusion 9 is utilised to resist against the unauthorised removal of the base while the door of the vehicle is closed so as to guard against theft.

Furthermore, the apparatus 1 comprises a surface fastener configured for fastening an underside of the base to the roof (or boot or bonnet) of the vehicle body substantially adjacent the door in use. In a preferred embodiment, the surface fastener is magnetic. Therefore, as can be seen in FIG. 1, the apparatus 1 comprises a recess 5 configured for receipt of a magnet 2 therein. In use, the magnet 2 may be covered with a covering within the recess 5 so as to be substantially invisible to the user. Further, the recess 5 may be configured so as to substantially locate the magnet 2 sufficiently proximate to the metallic surface of the vehicle so as to allow for adequate attraction by the magnet 2 so as to provide sufficient holding force for the base 7.

It should be noted that in other embodiments, other surface fastener mechanisms and arrangements may be utilised within the purposive scope of the embodiments described herein, including suction cups and the like.

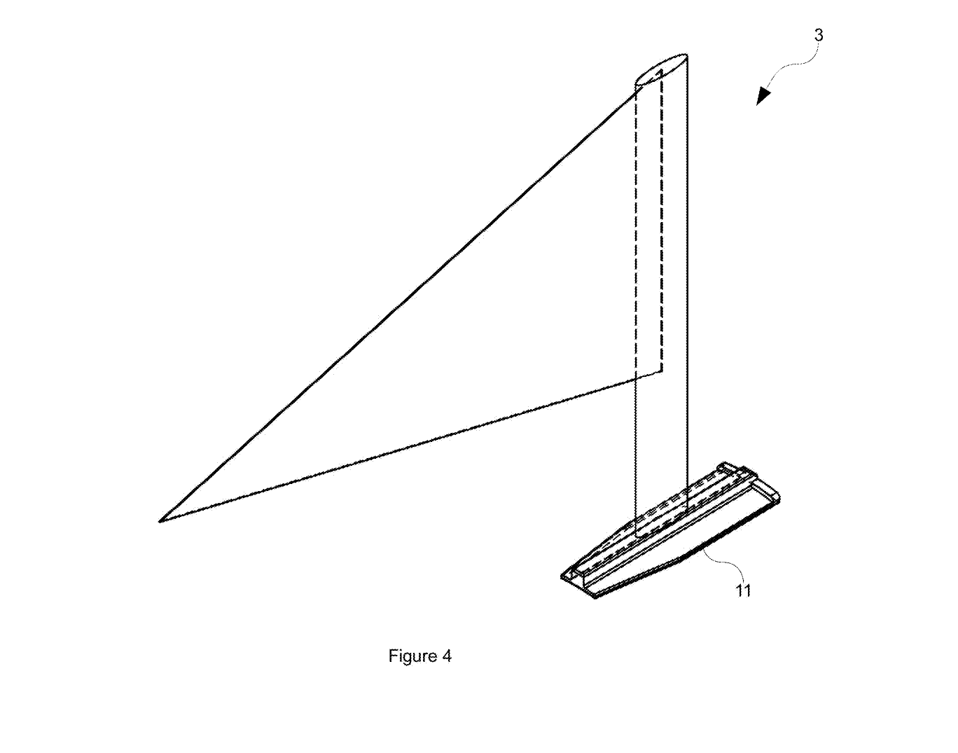

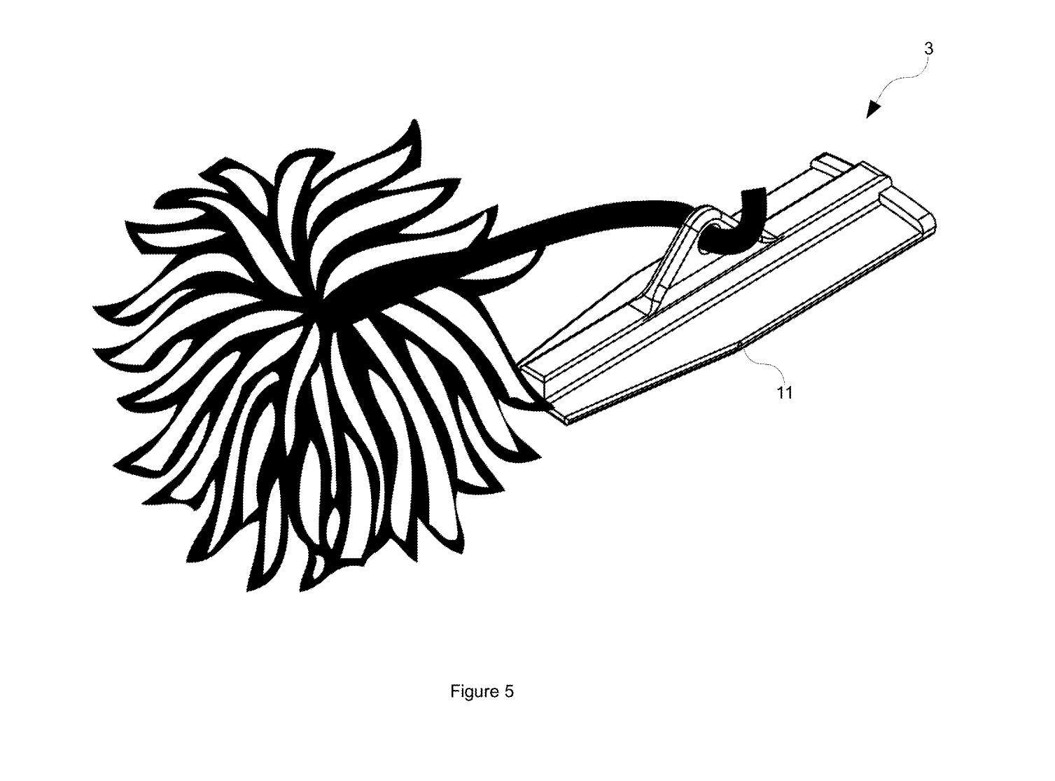

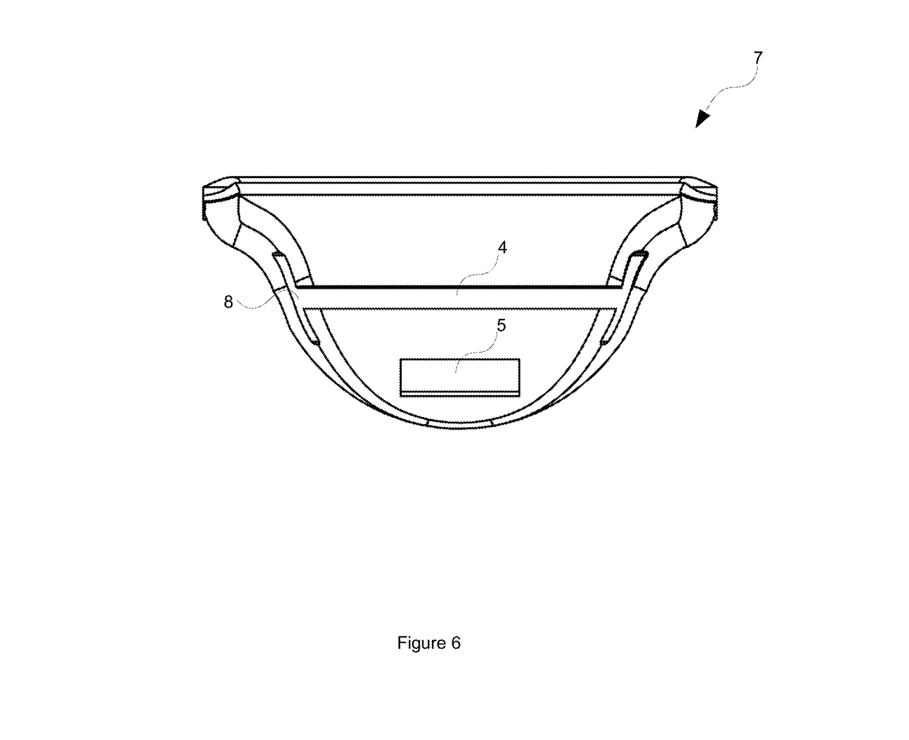

As is also shown, the apparatus 1 further comprises a flag device 3 secured by the base 7. It should be noted that in other embodiments, including those which are shown in FIGS. 4 and 5, other types and configurations of flag devices 3 (including pom-poms, mascots and the like) may be employed within the purposive scope of the embodiments described herein.

As such, in use, the door entrapment protrusion 9 is configured so as to substantially prevent the removal of the base 7 from the vehicle while the door is closed. Furthermore, the surface fastener is configured to secure the base 7 to the vehicle body so as to adequately support the flag device 3 while a vehicle is moving.

As can be appreciated from at least FIG. 1, the base 7 is substantially low profile, so as to reduce wind resistance.

Furthermore, as can be seen, the base is substantially elongate along the intended direction of travel so as to provide resilience to buffeting wind forces.

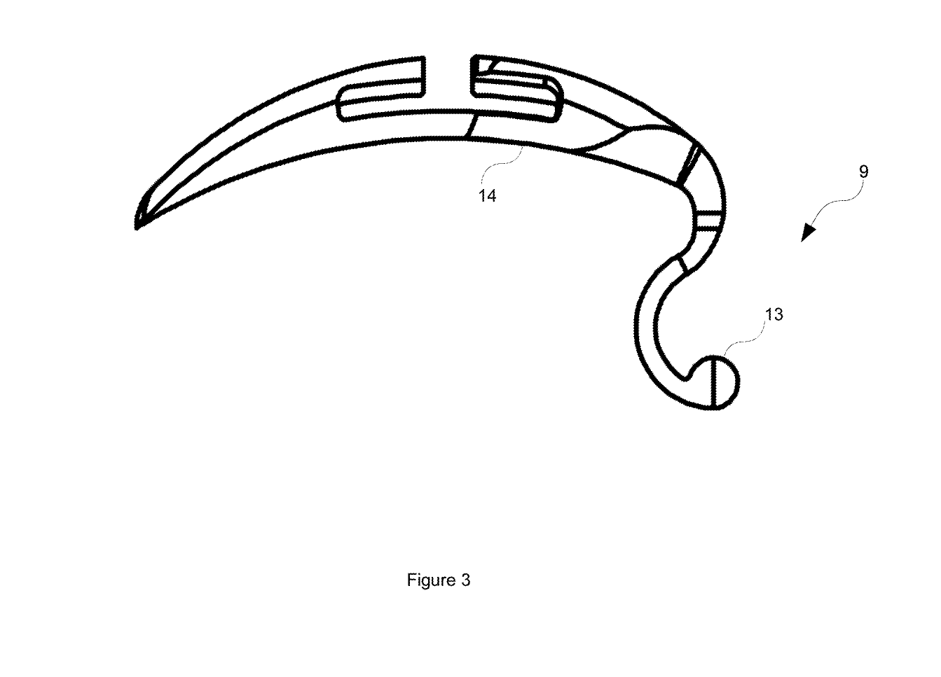

Furthermore, in a preferred embodiment, the base 7 is configured to conform to a contour of the vehicle body in use. Specifically, turning now to FIG. 3, there is shown a curved undersurface 14 of the base 7 configured to conform to the contour of the vehicle body in use.

In additional or alternative embodiments, the base 7 may be substantially flexible so as to adapt to the contour of the vehicle body. In this embodiment, the base 7 may be made from a flexible plastic, rubber or the like.

Now, in a preferred embodiment, so as to enhance the effectiveness of the door entrapment protrusion 9 in preventing the unauthorised removal of the apparatus 1 while the door of the vehicle is closed, as are substantially shown in FIG. 3, the door entrapment protrusion 9 comprises a widened distal end stop 13 configured to hinder the pulling of the protrusion 9 from between the closed surfaces of the door in use.

Furthermore, as can be seen from FIG. 3, in embodiments, the door entrapment protrusion 9 may be substantially S-shaped so as to allow the door entrapment protrusion 9 to reach between the closing surfaces of the door in use.

Furthermore, so as to snugly fit between the closed surfaces, and so as to be applicable for closing surfaces of differing configurations, in embodiments, the door entrapment protrusion may be substantially flexible. In this regard, the door entrapment protrusion 9 may be manufactured from rubber, flexible plastic or the like. In embodiments, the entire base 7 may be of a unitary construction manufactured from a flexible material. In alternative embodiments, the base 7 may be substantially rigid wherein a flexible protrusion 9 is fastened to the rigid base 7.

Now, in one embodiment, the flag device 3 may be permanently fastened to the base 7. However, in a preferred embodiment shown in FIG. 1, the base 7 further comprises an engagement means 8 configured for releasably engaging the flag device 3 in use.

In the embodiment shown, the flag device 3 comprises a foot 11. In this regard, the engagement 8 is substantially elongate open at at least one end and configured for slidable receipt of the foot 11 therein in use. As such, so as to engage the flag device 3 to the base 7, the user would push the foot 11 of the flag device 3 laterally along the elongate engagement means 8. Thereafter, to remove the flag device 3, the user would reverse the operation. In this embodiment, and as alluded to above, the flag device 3 is removable, so as to allow for the interchange of flag devices or the safekeeping of flag devices when not in use.

As can be seen, in the embodiment shown, the foot 11 is substantially elongate and may be tapered at an insertion end 10. The foot may further comprise a stop 12 opposite the insertion end 10 so as to limit the travel of the foot 11 within the engagement means 8.

In embodiments, the engagement means 8 may be open-ended at either end so as to allow the insertion of the flag device from either end, being especially advantageous for left and right hand positioning of a vehicle affecting the direction of travel.

In a preferred embodiment, the engagement means 8 is sized so as to provide a frictional engagement, interference fit or the like with the foot 11 so as to substantially prevent the inadvertent dislocation or dislodgement of the foot 10 from the engagement 8 in use.

In the embodiment shown, the flag device comprises an upright stem configured for supporting flag material 6. In embodiment, the flag material 6 may be made from differing material within the purposive scope of the embodiments described herein, such as cardboard, laminated cardboard, cloth, plastic sheeting, fluted cardboard and the like.

As alluded to above, in other embodiments, differing flag device 3 configurations may be equally applicable. For example, considering FIG. 4, there is shown a flag device 3 of an alternate construction wherein, as can be seen, the flag material 5 is tapered.

Furthermore, as is shown in FIG. 5, in embodiment, the flag device 3 may comprise a pom-pom device or the like. In this embodiment, the foot 11 presents a raised aperture adapted for the receipt of a portion of the device 3 there through.

Turning again to FIG. 1, in one embodiment, the flag device 3 has antitheft properties. In this regard, the flag device 3 is configured so as to substantially prevent the removal of the flag material 6 from the stem 15. In embodiments, the stem 15 may comprise a slot into which the flag material 6 is inserted, the slot comprising interference members, such as one-way arrowheads or the like so as to retain the material 6 therein.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

1. Apparatus for securing a vehicle flag device, the apparatus comprising:
a base comprising:
a door entrapment protrusion configured for protruding between closing surfaces of a door of a vehicle body in use so as to entrap the protrusion;
a surface fastener configured for fastening an underside of the base to the roof of the vehicle body substantially adjacent the door in use; and
a flag device secured by the base, wherein, in use:
the door entrapment protrusion is configured so as to substantially prevent the removal of the base from the vehicle while the door is closed; and
the surface fastener is configured to secure the base to the vehicle body so as to adequately support the flag device and secure the base to the roof while the vehicle is moving.

2. Apparatus as claimed in claim 1, wherein the base is substantially low profile.

3. Apparatus as claimed in claim 1, wherein the base is substantially elongate along the intended direction of travel so as to provide resilience to wind force.

4. Apparatus as claimed in claim 1, wherein the base is configured to conform to a contour of the vehicle body in use.

5. Apparatus as claimed in claim 4, wherein the base comprises a curved undersurface configured to conform to the contour.

6. Apparatus as claimed in claim 4, wherein the base is substantially flexible so as to adapt to the contour.

7. Apparatus as claimed in claim 1, wherein the door entrapment protrusion comprises a widened distal end stop configured to hinder the pulling of the protrusion from between the closing surfaces.

8. Apparatus as claimed in claim 1, wherein the door entrapment protrusion is substantially S-shaped.

9. Apparatus as claimed in claim 8, wherein the door entrapment protrusion is flexible.

10. Apparatus as claimed in claim 1, wherein the surface fastener is magnetic.

11. Apparatus as claimed in claim 10, wherein the base defines an upper recess for receiving a magnet therein.

12. Apparatus as claimed in claim 1, wherein the base further comprises an engagement means configured for releasably engaging the flag device in use.

13. Apparatus as claimed in claim 12, wherein the flag device comprises a foot and wherein the engagement means is substantially elongate, open at at least one end and configured for slidable receipt of the foot therein use.

14. Apparatus as claimed in claim 13, wherein the engagement means comprises an upper slit to allow the flag device to protrude therefrom.

15. Apparatus as claimed in claim 13, wherein the foot is substantially elongate.

16. Apparatus as claimed in claim 13, wherein the foot is tapered at an insertion end.

17. Apparatus as claimed in claim 13, wherein the foot comprises a stop opposite an insertion end.

18. Apparatus as claimed in claim 1, wherein the flag device comprises an upright stem configured for supporting flag material.

19. Apparatus as claimed in claim 1, wherein the upright stem is configured of the non-releasable engagement of the flag material.

20. Apparatus as claimed in claim 19, wherein the upright stem comprises one-way arrowheads.
